(19) United States
(12) Patent Application Publication
(10) Pub. No.: US 2003/0233597 A1
(43) Pub. Date: Dec. 18, 2003

(54) Method for eliminating a computer from a cluster

(76) Inventor: Joseph W. Armstrong, Santa Cruz, CA (US)

Correspondence Address: LERNER AND GREENBERG, P.A., POST OFFICE BOX 2480, HOLLYWOOD, FL, 33022-2480, US

(21) Appl. No.: 10/461,907

(22) Filed: Jun. 13, 2003

(30) Foreign Application Priority Data
Jun. 13, 2002 (EP) 02013454.0

(51) Int. Cl. H04L 1/22

(52) U.S. Cl. 714/24

(57) ABSTRACT

A method for eliminating a computer from a cluster to guarantee data integrity and application recovery on another computer includes installing, on each cluster node, a shutdown facility with a list of shutdown agents. The shutdown agents are independent executable programs that implement a shutdown method.

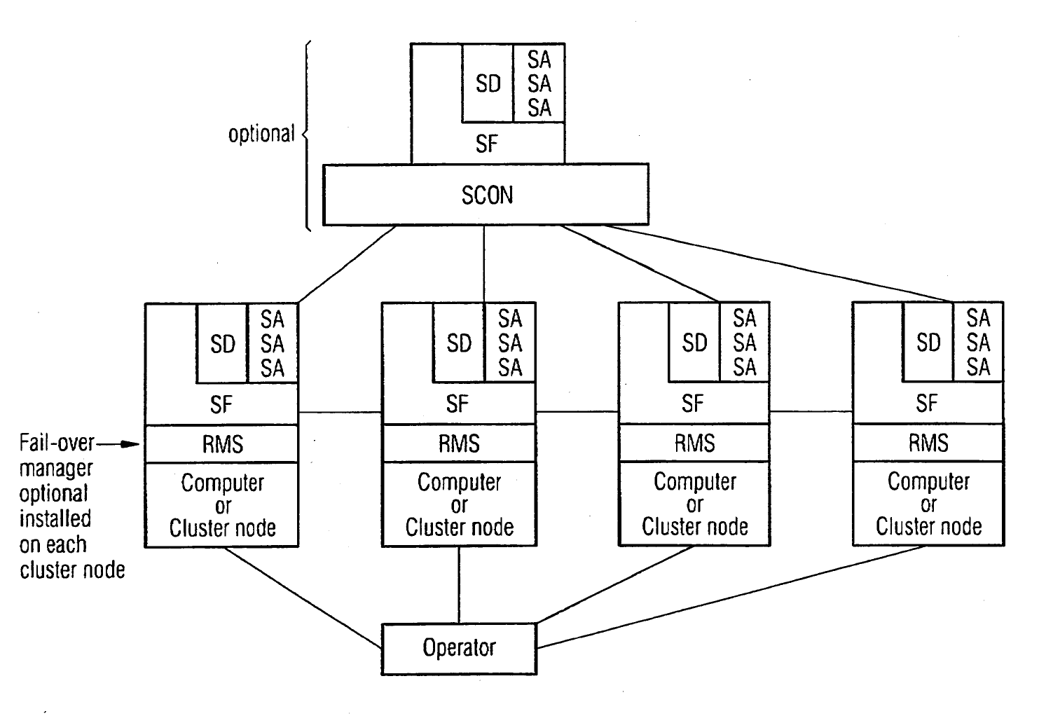

### BACKGROUND OF THE INVENTION

### FIELD OF THE INVENTION

The invention relates to a method for eliminating a computer from a cluster of two or more computers to guarantee data integrity and application recovery on another computer.

The method described in the following text is disclosed in German Patent DE 198 37 008 C2. A cluster normally has a cluster host and cluster nodes. The cluster nodes are administrated by software called cluster foundation, which is installed on the cluster host. The cluster foundation provides the basic central services. These services include, for example, sign-of-life monitoring between cluster nodes. In addition to these services, services such as fail-over manager for high availability and services for parallel databases can be added on depending on the application area. Services for dynamic load balancing opens the way to Internet application areas such as e-commerce and application hosting. The basis for almost all high availability solutions is a powerful and flexible fail-over manager in the background. In the case of the prime cluster from the applicant, the fail-over manager is called reliant monitor software (RMS). RMS is a generic monitor observation of nodes in a cluster and for the fail-over control of the applications.

For sign-of-life monitoring between the cluster nodes, what must be detected is whether there is a real breakdown of one of the cluster nodes or there is a problem in the communication between the clustered nodes. If there is a problem in the communication between the cluster nodes, the problem must be located and it must be decided which of the computers has to be shut down.

The RMS as the fail-over manager has access to all computers in the cluster and to all connections between the computers in the cluster. The Single Console (SCON) has the ability to stop or shut down every computer in the cluster or to reboot them. All RMS instances in the cluster send a message to the SCON if a sign-of-life message of another computer in the cluster is missing. With a missing sign-of-life message of one computer in the cluster, the data integrity could not be guaranteed, which means that this computer must be eliminated from the cluster. Therefore, the message from RMS to the SCON is called a shutdown request or a kill request. If there are n computers connected to a cluster and one node or computer sends no sign-of-life message the SCON receives n−1 shutdown requests. In this existing system the SCON collects and evaluates the shutdown requests and eliminates the defect machine or computer from the cluster.

The problem is that, with the existing technology, the SCON is a single point of failure for node elimination processing, no redundant shut down methods are supported, no interaction with the cluster foundation is supported, the existence of a fail-over manager is required, and the SCON introduces extra cost to a customer as they are required to purchase an addition machine on which to run the SCON software.

### SUMMARY OF THE INVENTION

It is accordingly an object of the invention to provide a method for eliminating a computer from a cluster that overcomes the hereinafore-mentioned disadvantages of the heretofore-known devices and methods of this general type and that provides a node elimination facility that will be available in clusters with or without a fail-over manager and with or without cluster foundation. The node elimination facility will be run on every node in the cluster so that it does not represent a single point of failure for node elimination processing. The facility will also support redundant node elimination methods to increase the probability of successful node elimination. Finally, the facility will not require the purchase of an additional machine on which to run its software, thereby, reducing the costs of the cluster to the customer.

With the foregoing and other objects in view, there is provided, in accordance with the invention, a method for eliminating a computer from a cluster with at least two computers to guarantee data integrity and application recovery on another computer, including the steps of registering a number of independent shutdown agents with a shutdown facility and installing the shutdown facility and the shutdown agents on all computers in the cluster.

The invention provides a number of independent shutdown agents registered with a shutdown facility that is installed on every computer in the cluster.

The shutdown facility provides a general framework for invoking redundant, independent shutdown methods for such a purpose. The shutdown agents implement the shutdown methods. When a shutdown request is being processed, the shutdown facility has the possibility to iterate through the list of registered shutdown agents if needed and can, therefore, provide a higher probability of successful host elimination.

The shutdown facility and the shutdown agents are also installed on the cluster host with the fail-over manager if one exists.

The shutdown facility tracks the status of each shutdown agent so that an operator may be advised if a shutdown agent becomes unavailable.

In accordance with another mode of the invention, there is provided the step of installing the shutdown facility and the shut down agents on a Single Consol if the Single Consol exists.

In accordance with a further mode of the invention, the shutdown facility is provided with a shutdown daemon and at least one shutdown agent.

In accordance with an added mode of the invention, the shutdown agents are provided as independent commands that may be called by the shutdown daemon.

In accordance with an additional mode of the invention, the shutdown daemon is triggered by a command line request or an event of cluster foundation.

In accordance with yet another mode of the invention, the shutdown daemon is triggered by a command line request or an event of cluster foundation if the event of cluster foundation exists.

In accordance with yet a further mode of the invention, the shutdown request is fulfilled by calling at least one shutdown agent defined in a configuration file of the shutdown daemon.

The invention provides a list of shutdown agents in a configuration file that defines an ordered list of the shutdown agents such that the first shutdown agent in the list is a preferred shutdown agent that is issued first with the shutdown request and, if its response indicates a failure to shutdown the next shutdown agent, is issued until either a shutdown agent responds with a successful shutdown or all shutdown agents have been tried.

In accordance with yet an added mode of the invention, the status of each shutdown agent is tracked with the shutdown daemon to enable an operator to be advised if a shutdown agent becomes unavailable.

With the objects of the invention in view, there is also provided a method for eliminating a computer from a cluster with two or more computers, including the steps of providing a cluster with at least two computers and guaranteeing data integrity and application recovery on another computer by registering a number of independent shutdown agents with a shutdown facility and installing the shutdown facility and the shutdown agents on all computers in the cluster.

Other features that are considered as characteristic for the invention are set forth in the appended claims.

Although the invention is illustrated and described herein as embodied in a method for eliminating a computer from a cluster, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

The FIGURE of the drawing is a block circuit diagram of a cluster of four computers or servers according to the invention.

### DESCRIPTION OF THE PREFERRED EMBODIMENTS

Referring now to the single figure of the drawing, it is seen that a cluster of four computers or servers (called cluster nodes) that are administrated by a fail-over manager that could, for example, be the existing RMS fail-over manager. The fail-over manager is optional and not necessary for the invention.

Each computer gives a sign-of-life message to the fail-over manager and to all other computers in the cluster. In the case that a sign-of-life message is missing, the computer with the missing sign-of-life message has to be eliminated. For such a purpose, a shutdown facility SF is installed on every computer. The shutdown facility includes a shutdown daemon SD and several shutdown agents SA. Each shutdown agent is a program in which a shutdown method is implemented.

The shutdown agents of the shutdown facility are independent commands that may be called by the shutdown daemons or by the SCON.

The shutdown daemon is triggered by either a command line request to shut down a cluster machine from the operator or an event called ENS from the cluster foundation.

The shutdown request is fulfilled by calling one or more shutdown agents defined in the shutdown daemon configuration file. After the shutdown has been verified, the shutdown daemon will transfer the node state to node-down if a fail-over manager or a cluster foundation CF is installed and running.

When a fail-over manager or a cluster foundation is not installed and running, the shutdown daemon will only respond to the command line request of the operator.

When the cluster foundation is installed and configured on the cluster host, the shutdown daemon registers with ENS to receive:

NODE_AVAILABLE

LEAVINGCLUSTER

LEFTCLUSTER

NODE_DOWN

These events are the existing events generated by the cluster foundation.

The shut down daemon tracks the state of the cluster nodes so that it can be determined when a computer needs to be eliminated.

The shutdown daemon has a configuration file that defines an ordered list of shutdown agents such that the first shutdown agent in the list is a preferred shutdown agent. This preferred shutdown agent is issued a shutdown request and, if its response indicates a failure to shutdown the second shutdown agent, is issued the shutdown request. This request/response is repeated until either a shutdown agent responds with a successful shutdown or all shutdown agents have been tried. If no shutdown agent is able to successfully shutdown a cluster node, then operator intervention is required and the node is left in the left cluster state.

Whatever configuration information is needed by the shutdown agent must be defined by the shutdown agent writer and configured in an independent configuration file. The shutdown agents are configured to be independent processes. The required operating environment of a shutdown agent is that:

a. installation requirements must be adhered to;

b. the required command line options must be supported; and

C. the required runtime action must be performed.

If a new shutdown agent is developed, the shutdown daemon and the “SCON”, if one exists, do not need to be re-qualified, only the new shutdown agent needs to be qualified.

The advantages of the shutdown facility SF over the existing RMS/SCON systems are:

a. Ability to shutdown a cluster node with or without running a fail-over manager (RMS);

b. Ability to shutdown a cluster node with or without running SCON;

c. Ability to shutdown a cluster node from any cluster service layer product;

d. The existing fail-over manager (RMS and SCON) system is optional on all clusters regardless of number of nodes and platform mixture;

e. Redundant shutdown methods will be available on clusters with SCON because the SCON will use its existing method as well as those methods implemented in the shutdown agents;

f. Redundant shutdown methods will be available on clusters without SCON because several shutdown agents are available and each shutdown agent implements a shutdown method;

g. Faster qualification cycles when introducing a new shutdown agent because the shutdown daemon and the fail-over manager (RMS/SCON), if one exists, do not need to be re-qualified; and

h. Active monitoring of configured shutdown agents so that an operator can be notified of a failure prior to that agent being needed to be used.

I claim:

1. A method for eliminating a computer from a cluster with at least two computers to guarantee data integrity and application recovery on another computer, which comprises:
registering a number of independent shutdown agents with a shutdown facility; and
installing the shutdown facility and the shutdown agents on all computers in the cluster.

2. The method according to claim 1, which further comprises installing the shutdown facility and the shut down agents on a Single Consol.

3. The method according to claim 1, which further comprises installing the shutdown facility and the shut down agents on a Single Consol when the Single Consol exists.

4. The method according to claim 1, which further comprises providing the shutdown facility with a shutdown daemon and at least one shutdown agent.

5. The method according to claim 4, which further comprises providing the shutdown agents as independent commands that may be called by the shutdown daemon.

6. The method according to claim 4, which further comprises triggering the shutdown daemon by a command line request or an event of cluster foundation.

7. The method according to claim 4, which further comprises triggering the shutdown daemon by a command line request or an event of cluster foundation if the event of cluster foundation exists.

8. The method according to claim 4, which further comprises fulfilling the shutdown request by calling at least one shutdown agent defined in a configuration file of the shutdown daemon.

9. The method according to claim 8, which further comprises:
providing the shutdown facility with a plurality of shutdown agents; and
defining an ordered list of the shutdown agents with the configuration file to define a first shutdown agent in the list as a preferred shutdown agent issued first when a shutdown request is being processed and, if a response of the preferred shutdown agent indicates a failure to shutdown, issuing a next shutdown agent until either a shutdown agent responds with a successful shutdown or all shutdown agents have been tried.

10. The method according to claim 4, which further comprises tracking the status of each shutdown agent with the shutdown daemon to enable an operator to be advised if a shutdown agent becomes unavailable.

11. The method according to claim 2, which further comprises providing the shutdown facility with a shutdown daemon and at least one shutdown agent.

12. The method according to claim 11, which further comprises providing the shutdown agents as independent commands that may be called by the shutdown daemon or the Single Consol.

13. The method according to claim 11, which further comprises triggering the shutdown daemon by a command line request or an event of cluster foundation.

14. The method according to claim 11, which further comprises fulfilling the shutdown request by calling at least one shutdown agent defined in a configuration file of the shutdown daemon.

15. The method according to claim 14, which further comprises:
providing the shutdown facility with a plurality of shutdown agents; and
defining an ordered list of the shutdown agents with the configuration file to define a first shutdown agent in the list as a preferred shutdown agent issued first when a shutdown request is being processed and, if a response of the preferred shutdown agent indicates a failure to shutdown, issuing a next shutdown agent until either a shutdown agent responds with a successful shutdown or all shutdown agents have been tried.

16. The method according to claim 11, which further comprises tracking the status of each shutdown agent with the shutdown daemon to enable an operator to be advised if a shutdown agent becomes unavailable.

17. A method for eliminating a computer from a cluster with two or more computers, which comprises:
providing a cluster with at least two computers; and
guaranteeing data integrity and application recovery on another computer by:
registering a number of independent shutdown agents with a shutdown facility; and
installing the shutdown facility and the shutdown agents on all computers in the cluster.
